(19) United States
(12) Patent Application Publication
(10) Pub. No.: US 2024/0301196 A1
(43) Pub. Date: Sep. 12, 2024

(54) THERMOPLASTIC COMPOSITIONS AND USES THEREOF

(71) Applicant: SHPP GLOBAL TECHNOLOGIES B.V., Bergen op Zoom (NL)

(72) Inventors: Fabio DI LENA, Bergen op Zoom (NL); Roland Sebastian ASSINK, Middelburg (NL); Tony FARRELL, Bergen op Zoom (NL)

(21) Appl. No.: 18/272,729

(22) PCT Filed: May 12, 2022
(86) PCT No.: PCT/IB2022/054442

§ 371 Date: Jul. 17, 2023

(30) Foreign Application Priority Data
May 13, 2021 (EP) 21173753.1

(51) Int. Cl. C08L 33/12; C08K 5/101

(52) U.S. Cl. CPC C08L 33/12; C08K 5/101; C08L 2205/03; C08L 2207/066

(57) ABSTRACT

A composition includes particular amounts of a poly(methyl methacrylate), a poly(carbonate-siloxane), and a low density polyethylene. Also provided is a method of making the composition and articles including the composition.

### BACKGROUND

This disclosure relates to thermoplastic compositions including methacrylate polymers, poly(carbonate-siloxane)s, and low density polyethylene, as well as methods for the manufacture of the compositions, uses and articles containing the compositions.

Poly(methyl methacrylate) (PMMA) is useful for scratch resistant and transparent or high gloss thermoplastic compositions. However, due to its low impact strength PMMA is not generally well suited for demanding applications such as automotive components or consumer electronics (e.g., consumer electronic housings). Polycarbonate (PC) has excellent impact strength and transparency but tends to lack scratch-resistant properties.

Efforts to improve scratch resistance include, for example, hard-coating the compositions or inclusion of anti-scratch additives into the compositions. These approaches may not be desirable in all applications. For example, in the case of hard-coating, an expensive additional processing step is introduced to the manufacturing process. Addition of impact modifiers has been explored to improve impact strength; however, impact modifiers can negatively affect scratch visibility (e.g., by making scratches appear whiter).

Accordingly, there remains a continuing need in the art for scratch-resistant compositions having improved impact strength that do not require a hard-coating or scratch-resistant additives.

### SUMMARY

A composition comprises 55 to 89 weight percent of a poly(methyl methacrylate); 10 to 30 weight percent of a poly(carbonate-siloxane) having a siloxane content of 30 to 70 weight percent, preferably 35 to 65 weight percent, based on the total weight of the poly(carbonate-siloxane); and 1 to less than 5 weight percent of low density polyethylene; wherein the weight percent of each component is based on the total weight of the composition.

A method of making the composition comprises melt-mixing the components of the composition, and, optionally, extruding the composition.

An article comprises the composition.

The above described and other features are exemplified by the following detailed description.

### DETAILED DESCRIPTION

Provided herein is a composition having a combination of good scratch resistance and impact strength. The compositions include particular amounts of a poly(methyl methacrylate), a poly(carbonate-siloxane), and low density polyethylene.

Accordingly, a composition represents an aspect of the present disclosure. The composition comprises a poly(methyl methacrylate). Any suitable poly(methyl methacrylate) polymer or a copolymer thereof can be used. In an aspect, the poly(methyl methacrylate) can be a homopolymer, obtained by polymerization (e.g., free radical polymerization) of a methyl methacrylate monomer. In an aspect, the poly(methyl methacrylate) can be a copolymer, obtained by polymerization (e.g., free radical polymerization) of a methyl methacrylate monomer and at least one additional monomer suitable for copolymerization with methyl methacrylate. Suitable comonomers can be readily determined by one of skill in the art. For example, copolymerizable monomers can include, but are not limited to, C₂₋₁₀ alkyl(meth)acrylate monomers such as ethyl (meth)acrylate, propyl (meth)acrylate, n-butyl (meth)acrylate, tert-butyl (meth)acrylate, pentyl (meth)acrylate, or 2-ethylhexyl (meth)acrylate; (meth)acrylates derived from unsaturated alcohols such as oleyl (meth)acrylate, 2-propynyl (meth)acrylate, allyl (meth)acrylate or vinyl (meth)acrylate; aryl (meth)acrylates, such as benzyl (meth)acrylate or phenyl (meth)acrylate, where in each case the aryl can be substituted or unsubstituted; cycloalkyl (meth)acrylates, such as 3-vinylcyclohexyl (meth)acrylate, or bornyl (meth)acrylate; hydroxyalkyl (meth)acrylates, such as 3-hydroxypropyl (meth)acrylate, 3,4-dihydroxybutyl (meth)acrylate, 2-hydroxyethyl (meth)acrylate, or 2-hydroxypropyl (meth)acrylate; 1,4-butanediol (meth)acrylate; tetrahydrofurfuryl (meth)acrylate; vinyloxyethoxyethyl (meth)acrylate; ethylsulphinylethyl (meth)acrylate; 4-thiocyanatobutyl (meth)acrylate; ethylsulphonylethyl (meth)acrylate; thiocyanatomethyl (meth)acrylate; methylsulphinylmethyl (meth)acrylate; bis((meth)acryloyloxyethyl) sulphide; or trimethyloylpropane tri(meth)acrylate. In an aspect, the copolymerizable monomers can include amides of or nitrile derivatives of (meth)acrylic acid, such as N-(3-dimethylaminopropyl) (meth)acrylamide or (meth)acrylonitrile. In an aspect, the copolymerizable monomers can include 1-alkenes, such as 1-hexene, 1-heptene, or butene; branched alkenes, such as vinylcyclohexane, 3,3 dimethyl-1-propene, 3-methyl-1-diisobutylene, or 4-methyl-1-pentene; vinyl esters, such as vinyl acetate; styrene, omethylstyrene or oethylstyrene; substituted styrenes having (C₁₋₄ alkyl) or halogen substituent(s), such as vinyltoluene, p-methylstyrene, mono-chlorostyrenes, dichlorostyrenes, tribromostyrenes, or tetrabromostyrenes; heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinyl-pyrrolidone, 2-vinylpyrrolidone, N-vinylpyrrolidine, 3 vinylpyrrolidine, N-vinylcaprolactam, N-vinylbutyrolactam, vinyloxolane, vinylfuran, vinylthiophene, vinylthiolane, vinylthiazoles, hydrogenated vinylthiazoles, vinyloxazoles or hydrogenated vinyloxazoles; vinyl ethers; isoprenyl ethers; maleic acid derivatives, such as maleic anhydride, methylmaleic anhydride, maleimide, or methylmaleimide; or dienes, such as divinylbenzene. Combinations of any of the foregoing copolymerizable monomers can also be used.

In an aspect, the poly(methyl methacrylate) can have a methyl methacrylate content of at least 70 weight percent, or at least 80 weight percent, or at least 90 weight percent, or at least 95 weight percent, based on the total weight of the poly(methyl methacrylate) polymer. In an aspect, the poly(methyl methacrylate) comprises 100 weight percent methyl methacrylate repeating units.

In an aspect, the poly(methyl methacrylate) can include a combination of different poly(methyl methacrylate) homopolymers or copolymers (e.g., as a blend), for example poly(methyl methacrylate)s having different molecular weights or comprising different repeating unit compositions.

In an aspect, the weight average molecular weight of the poly(methyl methacrylate) can be, for example, 10,000 to 1,000,000 grams per mole (g/mol), or 20,000 to 1,000,000 g/mol, or 50,000 to 500,000 g/mol or 80,000 to 300,000 g/mol. Weight average molecular weight can be determined by gel permeation chromatography relative to poly(methyl methacrylate) standards.

In an aspect, the poly(methyl methacrylate) can have a melt volume flow rate of 7 cm³/10 min to 12 cm³/10 at 240° C., 2.16 kg, 300 s as measured in accordance with ISO 1133.

Poly(methyl methacrylate)s are available as, for example, ACRYLITE POQ66 from Evonik, PLEXIGLAS V920A or ALTUGLAS V825T, both available from Arkema, and combinations thereof.

In an aspect, the poly(methyl methacrylate) can be derived from post-consumer recycled or post-industrial recycled materials or can be produced from at least one monomer derived from bio-based or plastic waste feedstock.

The poly(methyl methacrylate) can be present in the composition in an amount of 55 to 89 weight percent, based on the total weight of the composition. Within this range, the poly(methyl methacrylate) can be present in an amount of 55 to 85 weight percent, or 60 to 80 weight percent, or 65 to 77 weight percent, or 65 to 75 weight percent, each based on the total weight of the composition.

In addition to the poly(methyl methacrylate), the composition further comprises a poly(carbonate-siloxane). The poly(carbonate-siloxane) comprises polycarbonate blocks comprising repeating units according to Formula (1)

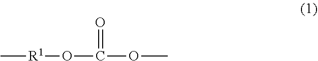

and polysiloxane blocks. In Formula (1), at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ can be derived from a bisphenol of formula (3)

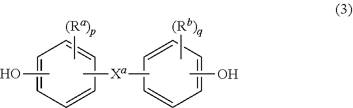

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group can be cyclic or acyclic, aromatic or non-aromatic, and can further comprise heteroatoms such as halogens, oxygen, nitrogen, sulfur, silicon, or phosphorous. The C₁₋₆₀ organic group can be disposed such that the C₆ arylene groups connected thereto are each connected to a common alkylidene carbon or to different carbons of the C₁₋₆₀ organic bridging group. In an aspect, p and q are each 1, and R^{a} and R^{b} are each a C₁₋₃ alkyl group, preferably methyl, disposed meta to the hydroxy group on each arylene group.

The polysiloxane blocks comprise repeating diorganosiloxane units as in formula (4)

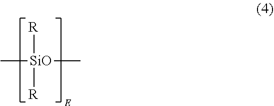

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups can be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups can be used in the same copolymer.

The value of E in formula (4) can vary widely depending on the type and relative amount of each component in the composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it can be desirable to use a relatively larger amount of the poly(carbonate-siloxane). Conversely, where E is of a higher value, e.g., greater than 40, a relatively lower amount of the poly(carbonate-siloxane) can be used. A combination of a first and a second (or more) poly(carbonate-siloxane)s can be used, wherein the average value of E of the first copolymer is less than the average value of E of the second copolymer.

In an aspect, the polysiloxane blocks are of formula (5)

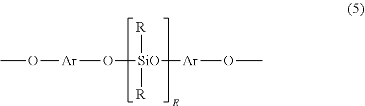

wherein E and R are as defined if formula (4); each R can be the same or different, and is as defined above; and Ar can be the same or different, and is a substituted or unsubstituted C₆₋₃₀ arylene, wherein the bonds are directly connected to an aromatic moiety. Ar groups in formula (5) can be derived from a C₆₋₃₀ dihydroxyarylene compound, for example a dihydroxyarylene compound of formula (3) or an aromatic dihydroxy compound of formula (6)

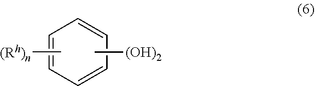

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine. Particular dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

In another aspect, polysiloxane blocks are of formula (7)

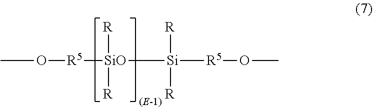

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (8):

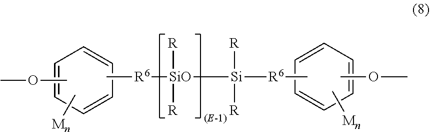

wherein R and E are as defined above. R⁶ in formula (8) is a divalent C₂₋₈ aliphatic group. Each M in formula (8) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

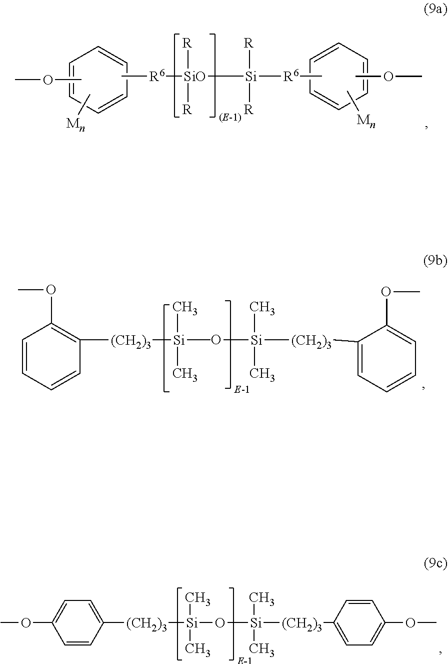

or a combination thereof, wherein E has an average value of 2 to 200, 2 to 125, 5 to 125, 5 to 100, 5 to 50, 20 to 80, or 5 to 20.

Blocks of formula (9) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane)s can then be manufactured, for example, by the synthetic procedure of European Patent Application Publication No. 0 524 731 A1 of Hoover, page 5, Preparation 2.

Transparent poly(carbonate-siloxane)s comprise carbonate units (1) derived from bisphenol A, and repeating siloxane units (9a), (9b), (9c), or a combination thereof (preferably of formula 9a), wherein E has an average value of 4 to 50, 4 to 15, preferably 5 to 15, more preferably 6 to 15, and still more preferably 7 to 10. The transparent copolymers can be manufactured using one or both of the tube reactor processes described in U.S. Patent Application No. 2004/0039145A1 or the process described in U.S. Pat. No. 6,723,864 can be used to synthesize the poly(carbonate-siloxane)s.

The poly(carbonate-siloxane) has a siloxane content of 30 to 70 wt %, based on the total weight of the poly(carbonate-siloxane). Within this range, the poly(carbonate-siloxane) can have a siloxane content of greater than 30 to 70 weight percent, or 35 to 70 weight percent, or 35 to 65 weight percent. As used herein, “siloxane content” of a poly(carbonate-siloxane) refers to the content of siloxane units based on the total weight of the poly(carbonate-siloxane).

In an aspect, the poly(carbonate-siloxane) can be derived from post-consumer recycled or post-industrial recycled materials or can be produced from at least one monomer derived from bio-based or plastic waste feedstock.

In an aspect, the poly(carbonate-siloxane) can have a weight average molecular weight of 17,000 to 50,000 g/mol. Within this range, the weight average molecular weight can be 17,000 to 45,000 g/mol, or 20,000 to 45,000 g/mol, or 30,000 to 45,000 g/mol, or 32,000 to 36,000 g/mol, or 30,000 to 45,000 g/mol, or 32,000 to 45,000 g/mol, or 35,000 to 45,000 g/mol, or 35,000 to 40,000 g/mol, or 32,000 to 40,000 g/mol. In an aspect, the poly(carbonate-siloxane) can have a weight average molecular weight of 26,000 to 45,000 g/mol, or 30,000 to 45,000 g/mol, or 35,000 to 40,000 g/mol. The weight average molecular weight can be determined by gel permeation chromatography using a crosslinked styrene-divinyl benzene column, at a sample concentration of 1 milligram per milliliter, and as calibrated using polystyrene standards and calculated for polycarbonate.

The poly(carbonate-siloxane)s can have a melt volume flow rate, measured at 300° C./1.2 kg, of 1 to 50 cubic centimeters per 10 minutes (cc/10 min), preferably 2 to 30 cc/10 min. Combinations of the poly(carbonate-siloxane)s of different flow properties can be used to achieve the overall desired flow property.

The poly(carbonate-siloxane) can be present in the composition in an amount effective to provide a total siloxane content of 1 to 25 weight percent, or 3 to 22 weight percent or 3 to 15 weight percent, or 3 to 10 weight percent, or 5 to 10 weight percent, each based on the total weight of the composition.

In an aspect, the composition can have a total siloxane content of 6 to 10 weight percent, and the weight average molecular weight of the poly(carbonate-siloxane) can be greater than 21,000 g/mol. In an aspect, the composition can have a total siloxane content that is 6 to 10 weight percent, and the weight average molecular weight of the polycarbonate-siloxane copolymer can be greater than 25,000 to less than 45,000 g/mol. In an aspect, the composition can have a total siloxane content that is 6 to 10 weight percent, and the weight average molecular weight of the poly(carbonate-siloxane) can be greater than 30,000 to less than 40,000 g/mol.

The poly(carbonate-siloxane) can be present in the composition in an amount of 10 to 30 weight percent, based on the total weight of the composition. Within this range, the poly(carbonate-siloxane) can be present in an amount of 12 to 25 weight percent, or 12 to 23 weight percent, each based on the total weight of the composition.

In an aspect, the composition comprises less than or equal to 5 wt % or less than or equal to 1 wt %, or less than or equal to 0.1 wt % of an auxiliary poly(carbonate-siloxane) comprising 70 to 98 wt %, more preferably 75 to 97 wt % of carbonate units and less than 30 wt %, or 2 to less than 30 wt %, or 3 to 25 wt % siloxane units. In an aspect, an auxiliary poly(carbonate-siloxane) can be excluded from the composition.

In addition to the poly(methyl methacrylate) and the poly(carbonate-siloxane), the composition further comprises low density polyethylene (LDPE). LDPE is a branched polyethylene. LDPE generally has decreased crystallinity and lower density. For example, the density of LDPE can be less than 0.940 g/cm³, or 0.91 to 0.93 g/cm³, for example as determined according to ASTM D792. LDPE can be prepared at high temperatures and pressures, which results in complex branched molecular structures. The amount of branching and the density can be controlled by the polymerization conditions.

The low density polyethylene can be present in the composition in an amount of 1 to less than 5 weight percent, based on the total weight of the composition. Within this range, the low density polyethylene can be present in an amount of 1 to 4.5 weight percent, or 1 to 4 weight percent, or 1 to 3.5 weight percent, or greater than 1 to 3.5 weight percent, or 1.5 to 3.5 weight percent, each based on the total weight of the composition.

The composition can optionally further comprise an impact modifier. Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

A specific type of impact modifier is an elastomer-modified graft copolymer comprising (i) an elastomeric (i.e., rubbery) polymer substrate having a Tg less than 10° C., more preferably less than −10° C., or more preferably −40 to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene or styrene; or combinations thereof. Materials suitable for use as the rigid phase include, for example, monovinyl aromatic monomers such as styrene and alpha-methyl styrene, and monovinylic monomers such as acrylonitrile, acrylic acid, methacrylic acid, and the C₁₋₆ esters of acrylic acid and methacrylic acid, preferably methyl methacrylate.

In an aspect, exemplary impact modifiers can include those based on acrylic copolymers. For example, an acrylic copolymer-containing impact modifier can comprise acrylonitrile-butadiene-styrene polymer (ABS) such as bulk polymerized ABS (BABS), an acrylonitrile-styrene-butyl acrylate (ASA) polymer, a methyl methacrylate-acrylonitrile-butadiene-styrene (MABS) polymer, a methyl methacrylate-butadiene-styrene (MBS) polymer, and an acrylonitrile-ethylene-propylene-diene-styrene (AES) polymer, or a combination thereof.

In an aspect, the impact modifier can be a multilayer impact modifier comprising a core and one or more shells. As described above, the core can be elastomeric and the shell can be rigid. In an aspect, the multilayer impact modifier can comprise butyl acrylate as a rubber component. In an aspect, the multilayer impact modifier can comprise methyl methacrylate polymer as the rigid component. In an aspect, the multilayer impact modifier can have a core-shell-shell structure in which a core (C) is surrounded by a first shell (S1) which is in turn surrounded by a second shell (S2). The core and first shell (e.g., the inner shell) can be elastomeric and the second shell (e.g., the outer shell) can be rigid. In an aspect, the weight ratio of C:(S1+S2) can be 10:90 to 40:60. The core and the first shell can contain an elastomeric (i.e., rubbery) polymer phase having a glass transition temperature (Tg) of less than 10° C., or less than −10° C., or −40 to −80° C. The second shell can contain a rigid polymeric superstrate grafted to the elastomer phase. In an aspect, the core can contain a first butyl acrylate polymer. In an aspect, the first shell can contain a second butyl acrylate polymer. In an aspect, the second shell can contain at least 50 weight percent of a methyl methacrylate polymer based on the total weight of the second shell. In an aspect, the multilayer impact modifier can have a particle size of 100 to 1000 nanometers (nm), for example 150 to 500 nm, or 175 to 250 nm. In an aspect, the number average particle diameter of the multilayer impact modifier can be 30 to 400 nm. Particle size can be determined by methods which are generally known, for example light scattering methods.

In an aspect, the core of the multilayer impact modifier can comprise a core polymer comprising 40 to 99.9 weight percent, or 55 to 90 weight percent of alkyl methacrylate repeat units, alkyl acrylate repeat units or styrenic repeat units; 0 to 59.9 weight percent of a copolymerizable monomer other than the alkyl methacrylate, alkyl acrylate, or styrenic repeat units; and 0.1 to 5 weight percent of a polyfunctional monomer, based on the total weight of the core. In an aspect, the core polymer can be a butyl acrylate polymer.

In an aspect, the first shell of the multilayer impact modifier can comprise a first shell polymer comprising 50 to 99.9 weight percent, preferably 70 to 99 weight percent of a (C₂₋₈ alkyl) acrylate; 0 to 49.9 weight percent, preferably 0 to 29 weight percent of a copolymerizable vinyl monomer that is not an alkyl acrylate; and 0.1 to 10 weight percent, preferably 0.1 to 5 weight percent of a polyfunctional monomer, based on the total weight of the first shell. Polymerization of the monomers for the first shell in the presence of the core polymers can result in the core polymer being mainly distributed at the center portion of the impact modifier. In an aspect, the first shell polymer can be a butyl acrylate polymer.

In an aspect, the second shell of the multilayer impact modifier can be a graft component. In an aspect, second shell can contain homopolymer or a copolymer derived from a styrenic compound, (meth)acrylonitrile, (meth)acrylic acid, a (C₁₋₆ alkyl) (meth)acrylate, or a combination thereof. In an aspect, the second shell can contain, 50 to 100 weight percent, preferably 80 to 100 weight percent of methyl methacrylate repeat units; and 0 to 50 weight percent, preferably 0 to 20 weight percent of a copolymerizable vinyl monomer other than the methyl methacrylate, based on the total weight of the outer shell. In an aspect, the outer shell polymer can be a methyl methacrylate polymer.

In an aspect, the multilayer impact modifier can have a refractive index of 1.45 to 1.55, or 1.47 to 1.51, or about 1.49, or at least any one of, equal to any one of, or between any two of 1.45, 1.46, 1.47, 1.48, 1.49, 1.5, 1.50, 1.51, 1.52, 1.53, 1.54, and 1.55. In an aspect, the ratio of refractive indexes of the poly(methyl methacrylate) and the multilayer impact modifier can be 1.05:1 to 1:1.05.

In an aspect, the rubber content of the impact modifier can be 30 to 90 weight percent. Impact modifiers can be as described, for example, in U.S. Publication No. 2013/0184375. In an aspect, the impact modifier can be a powder product with having a multi-layer structure which comprises butyl acrylate as a rubber component, such as KANE ACE M-210 available from Kaneka.

When present, the impact modifier can be included in the composition in an amount of 10 to 30 weight percent, based on the total weight of the composition. Within this range, the impact modifier can be present in an amount of 10 to 25 weight percent, or 10 to 20 weight percent, or 12 to 18 weight percent, or 13 to 17 weight percent, each based on the total weight of the composition.

In addition to the poly(methyl methacrylate), the poly(carbonate-siloxane), the low density polyethylene, and optionally, the impact modifier, the composition can further optionally comprise an additive composition. The additive composition can include various additives ordinarily incorporated into polymer compositions of this type, with the proviso that the additive(s) are selected so as to not significantly adversely affect the desired properties of the thermoplastic composition, in particular scratch resistance and impact strength. Such additives can be mixed at a suitable time during the mixing of the components for forming the composition. Additives include processing aids, fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardant, hydrostabilizers, epoxy resins, and anti-drip agents. A combination of additives can be used, for example a combination of one or more of a hydrostabilizer, an epoxy resin, an anti-drip agent, a processing aid, a heat stabilizer, an ultraviolet light stabilizer, a colorant, an inorganic filler, preferably a clay. In general, the additives are used in the amounts generally known to be effective. For example, the total amount of the additives (other than any impact modifier, filler, or reinforcing agents) can be 0.1 to 10 weight percent, or 0.2 to 8 weight percent, or 0.2 to 5 weight percent, or 0.2 to 2 weight percent, or 0.2 to 1 weight percent, based on the total weight of the composition.

The composition of the present disclosure can optionally exclude other components not specifically described here. For example, the composition can exclude thermoplastic polymers other than the poly(methyl methacrylate) and the poly(carbonate-siloxane). The composition can optionally exclude impact modifiers other than the multilayer core shell impact modifier. The composition can optionally exclude other lubricants, processing aids, mold release agents or the like other than the low density polyethylene.

The composition can exhibit good scratch resistance and impact strength when a particular combination of poly(methyl methacrylate), poly(carbonate-siloxane), and low density polyethylene are present in the composition, each in particular amounts.

A molded sample of the composition can exhibit one or both of improved scratch resistance and impact strength. Without wishing to be bound by theory, it is believed that the unexpected combination of scratch resistance and impact strength is achieved by careful selection of the components of the compositions including the selection of weight percent of the siloxane units in the poly(carbonate-siloxane) and loading of the low density polyethylene, as well as careful selection of the impact modifier, when present.

In an aspect, a molded sample of the composition can exhibit good impact strength. For example, a molded sample of the composition can exhibit a notched Charpy impact strength of greater than 6 kJ/m², preferably 7 kJ/m² to 12 kJ/m² at 23° C., 4.2 J, as measured in accordance with ISO 179/1. A molded sample of the composition can exhibit a notched Izod impact strength of greater than 5 kJ/m², preferably 6 kJ/m² to 11 kJ/m² at 23° C., 2.75 J, as measured in accordance with ISO 180.

A molded sample of the composition can also exhibit good surface hardness and scratch resistance. For example, a molded sample of the composition can exhibit a hardness of greater than 400 N/mm², preferably 410 N/mm² to 550 N/mm², as measured in accordance with the Erichsen scratch hardness test at a force of 2 Newton (N). The composition can have a pencil hardness of at least H at 0.75 kgf, as specified by D3363-92A.

In an aspect, the composition exhibits a notched Charpy impact strength of 7 kJ/m² to 12 kJ/m² at 23° C., 4.2 J, as measured in accordance with ISO 179/1; and a notched Izod impact strength of 6 kJ/m² to 11 kJ/m² at 23° C., 2.75 J, as measured in accordance with ISO 180; and a hardness of 410 N/mm² to 550 N/mm², as measured in accordance with the Erichsen scratch hardness test at a force of 2 Newton (N); and a pencil hardness as specified by D3363-92A of at least H at 0.75 kgf.

In an aspect, the composition can comprise 65 to 75 weight percent of the poly(methyl methacrylate); 12 to 25 weight percent of the poly(carbonate-siloxane); 1.5 to 3.5 weight percent of the low density polyethylene; and optionally, 10 to 20 weight percent of an impact modifier. The poly(carbonate-siloxane) can comprise bisphenol A carbonate repeating units and poly(dimethyl siloxane) repeating units. The poly(carbonate-siloxane) can have a weight average molecular weight of 25,000 to 45,000 g/mol. The poly(carbonate-siloxane) can have a siloxane content of 35 to 65 weight percent based on the total weight of the poly(carbonate-siloxane). A molded sample of the composition can exhibit a notched Charpy impact strength of 7 kJ/m² to 12 kJ/m² at 23° C., 4.2 J, as measured in accordance with ISO 179/1; and a notched Izod impact strength of 6 kJ/m² to 11 kJ/m² at 23° C., 2.75 J, as measured in accordance with ISO 180; a hardness of 410 N/mm² to 550 N/mm², as measured in accordance with the Erichsen scratch hardness test at a force of 2 Newton (N); and a pencil hardness as specified by D3363-92A of at least H at 0.75 kgf.

The composition can be manufactured by various methods known in the art. For example, poly(methyl methacrylate) and poly(carbonate-siloxane) and other optional components can be first blended, optionally with any fillers, in a high speed mixer or by hand-mixing. The blend is then fed into the throat of a twin screw extruder via a hopper. Alternatively, at least one of the components can be incorporated into the composition by feeding it directly into the extruder at the through and/or downstream through a side stuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Shaped, formed, casted, or molded articles comprising the composition are also provided. The composition can be molded into useful shaped articles by a variety of methods, such as injection molding, extrusion, rotational molding, blow molding, and thermoforming. The article can be a molded article, a thermoformed article, an extruded film, an extruded sheet, a honeycomb structure, one or more layers of a multi-layer article, a substrate for a coated article, or a substrate for a metallized article.

Articles comprising the composition can be used in various consumer products. In an aspect, the article can be an automotive component. In an aspect, the article can be a consumer electronic component, for example a housing for a consumer electronic device.

Articles can include, but are not limited to, exterior automobile components (e.g., grill, mirror housing, pillar, spoiler, logo, roof rail, bezel, trim, fender), interior automobile components (e.g., decorative parts, electronic housings, instrument panel components, navigation system, housing frames), storage boxes, a personal equipment part, a home appliance component, furniture, appliance housings (e.g., robot cleaners, drones), and consumer electronics devices (e.g., device housings or components for laptops, phones, tablets, batteries, wireless charging, AR/VR goggles).

In an aspect the article can be an automotive bumper, an automotive exterior component, an automobile mirror housing, an automobile wheel cover, an automobile instrument panel or trim, an automobile glove box, an automobile door hardware or other interior trim, an automobile exterior light, an automobile part within the engine compartment, an agricultural tractor or device part, a window or a component thereof, a construction equipment vehicle or device part, a marine or personal water craft part, an all-terrain vehicle or all-terrain vehicle part, plumbing equipment, a valve or pump, an air conditioning heating or cooling part, a furnace or heat pump part, a computer housing, a computer housing or business machine housing or part, a housing or part for monitors, a computer router, a desk top printer, a large office/industrial printer, an electronics part, a projector part, an electronic display part, a copier part, a scanner part, an electronic printer toner cartridge, a handheld electronic device housing, a housing for a hand-held device, a hair drier, an iron, a coffee maker, a toaster, a washing machine or washing machine part, a microwave, an oven, a power tool, an electric component, an electric enclosure, a lighting part, a component for a lighting fixture, a dental instrument, a medical instrument, a medical or dental lighting part, an aircraft part, a train or rail part, a seating component, a sidewall, a ceiling part, cookware, a medical instrument tray, an animal cage, fibers, a laser welded medical device, fiber optics, a lens (auto and non-auto), a cell phone part, a greenhouse component, a sun room component, a fire helmet, a safety shield, safety glasses, a gas pump part, a humidifier housing, a thermostat control housing, an air conditioner drain pan, an outdoor cabinet, a telecom enclosure or infrastructure, a Simple Network Detection System (SNIDS) device, a network interface device, a smoke detector, a component or device in a plenum space, a medical scanner, X-ray equipment, a component for a medical application or a device, an electrical box or enclosure, and an electrical connector, a construction or agricultural equipment, and a turbine blade.

In an aspect the article can be a component of an aircraft interior or a train interior, an access panel, access door, air flow regulator, air gasper, air grille, arm rest, baggage storage door, balcony component, cabinet wall, ceiling panel, door pull, door handle, duct housing, enclosure for an electronic device, equipment housing, equipment panel, floor panel, food cart, food tray, galley surface, handle, housing for television, light panel, magazine rack, telephone housing, partition, part for trolley cart, seat back, seat component, railing component, seat housing, shelve, side wall, speaker housing, storage compartment, storage housing, toilet seat, tray table, tray, trim panel, window molding, window slide, a balcony component, baluster, ceiling panel, cover for a life vest, cover for a storage bin, dust cover for a window, layer of an electrochromic device, lens for a television, electronic display, gauge, or instrument panel, light cover, light diffuser, light tube, light pipes, mirror, partition, railing, refrigerator door, shower door, sink bowl, trolley cart container, trolley cart side panel, or window.

This disclosure is further illustrated by the following examples, which are non-limiting.

### Examples

Materials used for the following examples are provided in Table 1.

TABLE 1

| Component | Description | Supplier |
|---|---|---|
| PMMA | Poly(methyl methacrylate) available as ALTUGLAS | Arkema |
| | V920 | |
| PCSi | Poly(carbonate-siloxane) having a siloxane content of | SABIC |
| | 40 weight percent, average PDMS block length of 45 | |
| | units, having a Mw of 37,000 to 38,000 g/mol as | |
| | determined by gel permeation chromatography | |
| | calibrated using polystyrene standards and calculated for | |
| | polycarbonate, produced by interfacial polymerization | |
| | and endcapped with p-cumylphenol | |
| IM | Multilayer core-shell acrylic impact modifier | KANEKA |
| | comprising methyl methacrylate having an average | |
| | particle size of 220 nm, available as Kane Ace ™ M210 | |
| LDPE | Low density polyethylene obtained as LDPE 1922NO | SABIC |
| SEBS-1 | Polystyrene-poly(ethylene-butylene)-polystyrene | Kraton Performance Polymers Inc |
| | triblock copolymer having a polystyrene content of | |
| | 27.7-30.7 weight percent; obtained as KRATON G1650 | |
| HC | Hydrocarbon resin, CAS Reg. No. 123465-34-9; | Arakawa Chemical Industries |
| | obtained as ARKON P-125, Ltd. in pellet form and | |
| | ground to a powder before use | |
| EEA | Copolymer of ethylene and ethyl acrylate obtained as | Dow |
| | ELVALOY AC 2615 | |
| SEBS-2 | Polystyrene-poly(ethylene-butylene)-polystyrene | Kraton Performance Polymers Inc |
| | triblock copolymer, having a polystyrene content of | |
| | 30-33 weight percent and a negligible melt flow, | |
| | measured at 260° C. and 5 kilogram load according to | |
| | ASTM D1238; obtained as KRATON G1651 | |
| PAO | Hydrogenated polyalphaolefin obtained as Ineos | Ineos Oligomers |
| | Durasyn 166 | |
| GE | Glycerol ester obtained as Atmer 122 | Croda Polymer Additives |
| Lubricant | Slip agent obtained as Incromax 100 | Croda Polymer Additives |
| Si Gum | Pelletized silicone gum obtained as Genioplast Pellet S | Wacker Chemie AG |
| Si particle | Core-shell particle obtained as Genioperl P52 | Wacker Chemie AG |

The compositions of the following examples were prepared by blending the components together and extruding on a 37 mm twin-screw extruder. The compositions were subsequently injection molded at a temperature of 210 to 240° C., though it will be recognized by one skilled in the art that the method is not limited to these temperatures. Extrusion and molding conditions are shown in Tables 2 and 3, respectively.

TABLE 2

| Description | Unit | Quantity |
|---|---|---|
| Drying time | h | 6 |
| Hopper temp | ° C. | 40 |
| Zone 1 temp | ° C. | 180-200 |
| Zone 2 temp | ° C. | 200-220 |
| Zone 3 temp | ° C. | 230-250 |
| Zone 4 temp | ° C. | 250-260 |
| Zone 9 temp | ° C. | 255-260 |
| Screw speed | a.u. | 300 |

TABLE 3

| Description | Unit | Quantity |
|---|---|---|
| Drying time | h | 6 |
| Drying temp | ° C. | 75 |
| Hopper temp | ° C. | 40 |
| Zone 1 temp | ° C. | 210-220 |
| Zone 2 temp | ° C. | 220-230 |
| Zone 3 temp | ° C. | 230-240 |
| Nozzle temp | ° C. | 225-235 |
| Mold temp | ° C. | 50-60 |
| Screw speed | a.u. | 100 |
| Back pressure | bar | 5 |

Physical measurements were made using the following test methods. Unless noted otherwise, before testing, the pellets were pre-dried at 75° C. for 6 hours.

Heat deflection temperature (HDT) was determined in accordance with ISO 75 on a 80×10×4 mm sample bars at 0.45 MPa and 1.82 MPa.

Notched Izod impact Strength (INI) was determined in accordance with ISO 180 under a load of 5.5 lbf at a temperature of 23° C. on 80×10×4 mm bars.

Melt volume rate (MVR) was determined in accordance with ISO1133 under a load of 2.16 kg at 240° C. with a dwell time of 300 or 900 seconds. Before testing, the pellets were pre-dried at 75° C. for 6 hours.

Tensile properties were measured in accordance with ISO 527 at 50 mm/min at a temperature of 23° C. on standard ISO tensile bars.

Notched and unnotched Charpy impact strength was determined in accordance with ISO 179/1 at 23° C. using a 4.2 Joule pendulum on 80×10×4 mm bars.

Multiaxial impact (MAI) testing was performed in accordance with ISO 6602 at 23° C. with an impact speed of 4.4 m/s. Hardness was determined using an Erichsen scratch test in accordance with ISO 4586-2 at 2N.

An Erichsen Scratch test was conducted by lowering a needle onto the surface of a rotating sample at a load effective to provide a smooth scratch. A Dektak 6M profiler is used to drag the needle across the surface of the sample. Dimensions of the scratch can be measured, and the width of the scratch can be used to calculate hardness according to H_{w}=8F/π(S_{w})², where H_{w} is the hardness, F is the load in Newtons (N) applied by the Erichsen scratcher, and S_{w} is the scratch width in millimeters (mm).

Pencil hardness was determined in accordance with ASTM D3363 at 0.75 Kgf. The hardness is reported as the hardness of the hardest pencil that did not scratch the surface. The pencil hardness scale from softer to harder is 2B, B, HB, F, H, 2H, 3H, etc. Scratch whitening tests were carried out on molded plaques. Three circular scratches were generated on a MAI disk (Ø=100 mm, thickness=3 mm) at 1.5N, 2N and 4N with the Erichsen scratcher equipped with a conical tip with a 18 m diameter. The surface of the plaque was visually inspected for signs of scratch-whitening. Scratch-whitening is defined as a white line or color change visible, by eye, at all angles. Rating 1 is given when no visible white line/color change was present at 1.55N, 2N, and 4N at all angles. Rating 2 is given when a white line/color change is visible at 4N but not at 2N and 1.55N at all angles. Rating 3 is given when a white line/color change is visible at 2N and 4N but not at 1.55N at all angles. Rating 4 is given when a white line/color change is visible at 1.55N, 2N, and 4N at all angles.

Vicat softening temperature was determined in accordance with ISO 306.

Compositions and results are shown in Table 4. In Table 4, the amount of each component is provided in weight percent, based on the total weight of the composition.

TABLE 4

| | Units | E1 | E2 | E3 | CE1 | CE2 | E4 | E5 | CE3 | CE4 |
|---|---|---|---|---|---|---|---|---|---|---|
| Component | | | | | | | | | | |
| PMMA | wt % | 75.5 | 74.5 | 73.5 | 71.5 | 69.5 | 68 | 67 | 65 | 63 |
| PCSi | wt % | 22.5 | 22.5 | 22.5 | 22.5 | 22.5 | 15 | 15 | 15 | 15 |
| IM | wt % | | | | | | 15 | 15 | 15 | 15 |
| LDPE | wt % | 1 | 2 | 3 | 5 | 7 | 2 | 3 | 5 | 7 |
| Properties | | | | | | | | | | |
| Charpy Impact, | kJ/m² | 8 | 9 | 8 | 6 | 6 | 8 | 7 | 6 | 6 |
| notched | | | | | | | | | | |
| Charpy Impact, | kJ/m² | 75 | 83 | 73 | 17 | 15 | 78 | 98 | 24 | 15 |
| unnotched | | | | | | | | | | |
| INI | kJ/m² | 9 | 9 | 8 | 6 | 6 | 6 | 6 | 6 | 5 |
| Tensile Modulus | MPa | 2346 | 2251 | 2244 | 2164 | 2053 | 2020 | 1921 | 1827 | 1720 |
| Tensile Stress at Yield | MPa | 58 | 55 | 55 | — | — | 49 | 48 | 43 | 36 |
| Tensile Stress at Break | MPa | 45 | 45 | 44 | 49 | 42 | 41 | 41 | 40 | 34 |
| Tensile Strain | % | 5 | 5 | 5 | — | — | 4 | 5 | 4 | 4 |
| MAI, Puncture energy | J | 8 | 8 | 5 | 1 | 19 | — | 3 | 1 | 1 |
| MAI, Energy at max | J | 6 | 3 | 4 | 1 | 1 | — | 2 | 1 | 0 |
| force | | | | | | | | | | |
| MAI, Deflection at | mm | 5 | 7 | 6 | 3 | 4 | — | 4 | 4 | 3 |
| break | | | | | | | | | | |
| Erichsen scratch test | N/mm² | 458 | 449 | 449 | 399 | 388 | 425 | 417 | 417 | 348 |
| Pencil hardness | — | 2H | 2H | H | H | H | H | H | H | F |
| Scratch whitening | — | 3 | 2 | 2 | 3 | 3 | 2 | 2 | 2 | 3 |
| HDT, 0.45 MPa | ° C. | 91 | 92 | 91 | 93 | 93 | 84 | 90 | 89 | 89 |
| HDT, 1.8 MPa | ° C. | 78 | 78 | 77 | 78 | 78 | 72 | 74 | 74 | 74 |
| MVR, 300 s | cm³/10 | 3 | 3 | 3 | 3 | 4 | — | 3 | 3 | 3 |
| | min | | | | | | | | | |
| MVR, 900 s | cm³/10 | 3 | 3 | 3 | 3 | 4 | — | 3 | 3 | 3 |
| | min | | | | | | | | | |
| Vicat | ° C. | 101 | 101 | 99 | 95 | 93 | 94 | 92 | 90 | 88 |

When the compositions were molded, it was noted that compositions CE1 to CE4 showed delamination. However, no such phenomenon was observed with the compositions according to E1 to E5. This suggests that an LDPE content of 5 weight percent or more may cause undesirable blend instability during processing.

As shown in Table 4, the compositions of E2 to E5, including LDPE in an amount of 2-3 weight percent, showed the best combination of blend stability, mechanical and thermal properties and scratch resistance. The composition of E1 showed similar mechanical properties and thermal properties, but a slightly higher scratch visibility. Thus, for some applications, it may be desirable to include LDPE in an amount of greater than 1 weight percent.

Table 5 shows a comparison of the properties resulting from compositions of E2 to E5 and a poly(methyl methacrylate)/poly(carbonate-siloxane)/IM composition equivalent to E4 and E5 but with no LDPE (shown as CE5) and a poly(methyl methacrylate)/acrylonitrile-styrene-acrylate (ASA) blend available as GELOY XTWE480 from SABIC (shown as CE6). As shown in Table 5, the compositions of E2 to E5 exhibited higher Charpy impact strength relative to CE5, while maintaining excellent Erichsen hardness and pencil hardness, as well as an equivalent level of heat resistance. Moreover, the scratches generated on the surfaces of E2 to E4 were remarkably less visible than those on the surfaces of the compositions of CE5 and CE6.

TABLE 5

| Test | Unit | E2 | E3 | E4 | E5 | CE5 | CE6 |
|---|---|---|---|---|---|---|---|
| Charpy Impact, | kJ/m² | 9 | 8 | 8 | 7 | 9 | 5 |
| notched | | | | | | | |
| Tensile Modulus | MPa | 2251 | 2244 | 2020 | 1921 | 2400 | 2400 |
| HDT, 1.8 MPa | ° C. | 78 | 77 | 72 | 74 | 73 | 77 |
| Erichsen scratch | N/mm² | 449 | 449 | 425 | 417 | 402 | 425 |
| test, 2N | | | | | | | |
| Pencil hardness | — | 2H | H | H | H | 2H | 2H |
| Scratch visibility | — | 2 | 2 | 2 | 2 | 4 | 4 |

Table 6 and Table 7 show that when other elastomers (Table 6) and other lubricants (Table 7) were used in place of LDPE, although the mechanical and thermal properties were largely preserved, the scratch visibility remained as high as the composition of CE5 and CE6. The composition of CE21 (including 3 weight percent of a slip agent) exhibited some reduction in scratch visibility, but the compositions of E2 to E5 exhibited the lowest scratch resistance. The amount of each component is given in weight percent, based on the total weight of the composition.

TABLE 6

| | CE7 | CE8 | CE9 | CE10 | CE11 | CE12 | CE13 | CE14 | CE15 | CE16 | CE17 |
|---|---|---|---|---|---|---|---|---|---|---|---|
| Component | | | | | | | | | | | |
| PMMA | 75.5 | 75.5 | 75.5 | 74.5 | 73.5 | 75.5 | 74.5 | 73.5 | 75.5 | 74.5 | 73.5 |
| PCSi | 22.5 | 22.5 | 22.5 | 22.5 | 22.5 | 22.5 | 22.5 | 22.5 | 22.5 | 22.5 | 22.5 |
| SEBS-1 | 1 | | | | | | | | | | |
| HC | | 1 | | | | | | | | | |
| EEA | | | 1 | 2 | 3 | | | | | | |
| SEBS-2 | | | | | | 1 | 2 | 3 | | | |
| PAO | | | | | | | | | 1 | 2 | 3 |
| Properties | | | | | | | | | | | |
| Charpy Impact, | 5 | 5 | 9 | 9 | 9 | 9 | 9 | 7 | 8 | 8 | 7 |
| notched | | | | | | | | | | | |
| Tensile Modulus | 243 | 247 | 230 | 2279 | 2222 | 2258 | 2252 | 2182 | 2340 | 2269 | 2338 |
| | 8 | 4 | 8 | | | | | | | | |
| HDT, 1.8 MPa | 77 | 78 | 76 | 75 | 74 | 78 | 79 | 75 | 73 | 73 | 73 |
| Erichsen scratch test | 449 | 514 | 433 | 413 | 433 | 425 | 421 | 413 | 449 | 437 | 437 |
| Pencil hardness | 2H | 2H | H | H | H | 2H | H | H | 2H | 2H | 2H |
| Scratch visibility | 4 | 4 | 4 | 4 | 4 | 4 | 4 | 4 | 4 | 4 | 4 |

TABLE 7

| | CE18 | CE19 | CE20 | CE21 | CE22 | CE23 | CE24 | CE25 | CE26 | CE27 | CE28 |
|---|---|---|---|---|---|---|---|---|---|---|---|
| Component | | | | | | | | | | | |
| PMMA | 75.5 | 75.5 | 74.5 | 73.5 | 75.5 | 69 | 69 | 69 | 69 | 69 | 69 |
| PCSi | 22.5 | 22.5 | 22.5 | 22.5 | 22.5 | 29 | 27 | 25 | 29 | 27 | 25 |
| GE | 1 | | | | | | | | | | |
| Lubricant | | 1 | 2 | 3 | | | | | | | |
| Si Gum | | | | | 1 | 1 | 3 | 5 | | | |
| Si particle | | | | | | | | | 1 | 3 | 5 |
| Properties | | | | | | | | | | | |
| Charpy Impact, | 6 | 10 | 10 | 9 | 6 | 9 | 9 | 9 | 9 | 7 | 5 |
| notched | | | | | | | | | | | |
| Tensile Modulus | 2434 | 2324 | 2264 | 2269 | 2379 | 2166 | 2146 | 2141 | 2148 | 2146 | 2186 |
| HDT, 1.8 MPa | 74 | 72 | 71 | 71 | 79 | 72 | 72 | 73 | 73 | 74 | 74 |
| Erichsen scratch test | 466 | 449 | 433 | 425 | 433 | 385 | 378 | 372 | 378 | 413 | 354 |
| Pencil hardness | 2H | 2H | H | H | 2H | F | HB | HB | HB | F | F |
| Scratch visibility | 4 | 4 | 4 | 3 | 4 | 4 | 4 | 4 | 4 | 4 | 4 |

Various compositions were also subjected to Ford's scratch resistance test, in accordance with FLTM BO 162-01, and Ford's mar resistance test according to FLTM BI 161-01. The scratch and mar visibility were quantified by measuring the optical contrast of each scratch and mar line with a dual camera optical system capturing both the off-specular contrast (OSC) and the specular contrast (SC). For the scratch, the shutter speed for the OSC camera was set at 0.5 whereas the shutter speed for the SC camera was set at 0.005. For the mar, the shutter speed for the OSC camera was set at 0.1 whereas the shutter speed for the SC camera was set at 0.005. OSC relates to color variation whereas SC to the gloss loss. The composition of E2 to E5 were again compared with the compositions of CE5 and CE6, described above, as well as CE29, a polycarbonate resin obtained LEXAN SLX2271T from SABIC, CE30, a polycarbonate/acrylonitrile-styrene-acrylate (ASA) blend available as GELOY XP4034 from SABIC, and CE31, a poly(methyl methacrylate)/poly(carbonate-siloxane) composition, equivalent to E1-E3 but with no LDPE.

The results are shown in Table 8, where higher OSC and SC values indicate higher visibility of the scratch and the mar on the surface. As shown in Table 8, the compositions of E2 to E5 scored better than CE5, CE31, CE6, CE29, and CE30 in terms of scratch and mar visibility.

TABLE 8

| | FLTM BO 162-01 | | | | | | | | | | | |
|---|---|---|---|---|---|---|---|---|---|---|---|---|
| | OSC (a.u.) | | | | | SC (a.u) | | | | | FLTM BI 161-01 | |
| | 2N | 3N | 7N | 10N | 15N | 2N | 3N | 7N | 10N | 15N | OSC (a.u.) | SC (a.u.) |
| CE29 | 92 | 105 | 182 | 344 | 457 | 66 | 81 | 130 | 434 | 635 | 970 | 454 |
| CE30 | 96 | 106 | 164 | 243 | 512 | 115 | 170 | 379 | 528 | 641 | 477 | 542 |
| CE31 | 94 | 127 | 338 | 97 | 441 | 64 | 143 | 265 | 353 | 451 | 299 | 317 |
| CE6 | 95 | 98 | 122 | 132 | 124 | 95 | 103 | 157 | 176 | 320 | 194 | 386 |
| CE5 | 155 | 245 | 333 | 259 | 597 | 132 | 215 | 287 | 121 | 495 | 251 | 399 |
| E4 | 91 | 87 | 90 | 90 | 92 | 57 | 58 | 86 | 103 | 157 | 368 | 357 |
| E5 | 91 | 99 | 103 | 119 | 114 | 63 | 65 | 68 | 80 | 97 | 290 | 212 |
| E2 | 86 | 102 | 211 | 106 | 113 | 67 | 95 | 328 | 158 | 367 | 305 | 242 |
| E3 | 87 | 89 | 105 | 94 | 97 | 61 | 69 | 195 | 115 | 237 | 296 | 218 |

This disclosure further encompasses the following aspects.

Aspect 1: A composition comprises 55 to 89 weight percent of a poly(methyl methacrylate); 10 to 30 weight percent of a poly(carbonate-siloxane) having a siloxane content of 30 to 70 weight percent, preferably 35 to 65 weight percent, based on the total weight of the poly(carbonate-siloxane); and 1 to less than 5 weight percent of low density polyethylene; wherein the weight percent of each component is based on the total weight of the composition.

Aspect 2: The composition of aspect 1, wherein the composition exhibits one or more of: a notched Charpy impact strength of greater than 6 kJ/m², preferably 7 kJ/m² to 12 kJ/m² at 23° C., 4.2 J, as measured in accordance with ISO 179/1; a notched Izod impact strength of greater than 5 kJ/m², preferably 6 kJ/m² to 11 kJ/m² at 23° C., 2.75 J, as measured in accordance with ISO 180; a hardness of greater than 400 N/mm², preferably 410 N/mm² to 550 N/mm², as measured in accordance with the Erichsen scratch hardness test at a force of 2 Newton (N); and a pencil hardness as specified by D3363-92A of at least H at 0.75 kgf.

Aspect 3: The composition of aspect 1 or 2, further comprising 10 to 30 weight percent, preferably 10 to 20 weight percent of an impact modifier, preferably a core-shell impact modifier having a multilayer structure and comprising poly(butyl acrylate) and poly(methyl methacrylate).

Aspect 4: The composition of any of aspects 1 to 3, wherein the poly(carbonate-siloxane) comprises bisphenol A carbonate repeating units and poly(dimethyl siloxane) repeating units.

Aspect 5: The composition of any of aspects 1 to 4, wherein the poly(carbonate-siloxane) has a weight average molecular weight of 21,000 to 50,000 g/mol, or 25,000 to 45,000 g/mol, or 30,000 to 45,000 g/mol, or 32,000 to 43,000 g/mol, or 35,000 to 40,000 g/mol, as determined by gel permeation chromatography using a crosslinked styrene-divinyl benzene column, at a sample concentration of 1 milligram per milliliter, and as calibrated using polystyrene standards and calculated for polycarbonate.

Aspect 6: The composition of any of aspects 1 to 5, wherein the composition is free of a poly(carbonate-siloxane) having a siloxane content that is less than 30 weight percent, or less than 20 weight percent, or less than 10 weight percent, each based on the total weight of the poly(carbonate-siloxane).

Aspect 7: The composition of any of aspects 1 to 6, wherein the poly(carbonate-siloxane), the poly(methyl methacrylate), or both are derived from post-consumer recycled or post-industrial recycled materials or can be produced from at least one monomer derived from bio-based or plastic waste feedstock.

Aspect 8: The composition of any of aspects 1 to 7, comprising 1 to 4 weight percent, or 1 to 3.5 weight percent, or greater than 1 to 3.5 weight percent of the low density polyethylene.

Aspect 9: The composition of any of aspects 1 to 8, wherein the composition further comprises 0.1 to 10 weight percent, based on the total weight of the composition, of an additive composition.

Aspect 10: The composition of any of aspects 1 to 9, comprising 65 to 75 weight percent of the poly(methyl methacrylate); 12 to 25 weight percent of the poly(carbonate-siloxane); 1.5 to 3.5 weight percent of the low density polyethylene; and optionally, 10 to 20 weight percent of an impact modifier.

Aspect 11: The composition of aspect 10, wherein the poly(carbonate-siloxane) comprises bisphenol A carbonate repeating units and poly(dimethyl siloxane) repeating units; the poly(carbonate-siloxane) has a weight average molecular weight of 25,000 to 45,000 g/mol; the poly(carbonate-siloxane) has a siloxane content of 35 to 65 weight percent based on the total weight of the poly(carbonate-siloxane); and wherein a molded sample of the composition exhibits: a notched Charpy impact strength of 7 kJ/m² to 12 kJ/m² at 23° C., 4.2 J, as measured in accordance with ISO 179/1; and a notched Izod impact strength of 6 kJ/m² to 11 kJ/m² at 23° C., 2.75 J, as measured in accordance with ISO 180; and a hardness of 410 N/mm² to 550 N/mm², as measured in accordance with the Erichsen scratch hardness test at a force of 2 Newton (N); and a pencil hardness as specified by D3363-92A of at least H at 0.75 kgf.

Aspect 12: A method of making the composition of any of aspects 1 to 11, the method comprising melt-mixing the components of the composition, and, optionally, extruding the composition.

Aspect 13: An article comprising the composition of any of aspects 1 to 11.

Aspect 14: The article of aspect 13, wherein the article is an automotive component or a consumer electronic component.

Aspect 15: The article of aspect 14, wherein the article is an automotive body panel, an automotive instrument panel, an automotive console, automotive trim, an automotive visor; or an electrical or lighting cover, an electrical or lighting housing, an electrical or lighting enclosure; or a personal electronic device or a home appliance.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising
55 to 89 weight percent of a poly(methyl methacrylate);
10 to 30 weight percent of a poly(carbonate-siloxane) having a siloxane content of 30 to 70 weight percent, based on the total weight of the poly(carbonate-siloxane); and
1 to less than 5 weight percent of low density polyethylene;
wherein the weight percent of each component is based on the total weight of the composition.

2. The composition of claim 1, wherein the composition exhibits one or more of:
a notched Charpy impact strength of greater than 6 kJ/m² at 23° C., 4.2 J, as measured in accordance with ISO 179/1;
a notched Izod impact strength of greater than 5 kJ/m² at 23° C., 2.75 J, as measured in accordance with ISO 180;
a hardness of greater than 400 N/mm², as measured in accordance with the Erichsen scratch hardness test at a force of 2 Newton (N); and
a pencil hardness as specified by D3363-92A of at least H at 0.75 kgf.

3. The composition of claim 1, further comprising 10 to 30 weight percent of an impact modifier.

4. The composition of claim 1, wherein the poly(carbonate-siloxane) comprises bisphenol A carbonate repeating units and poly(dimethyl siloxane) repeating units.

5. The composition of claim 1, wherein the poly(carbonate-siloxane) has a weight average molecular weight of 21,000 to 50,000 g/mol, as determined by gel permeation chromatography using a crosslinked styrene-divinyl benzene column, at a sample concentration of 1 milligram per milliliter, and as calibrated using polystyrene standards and calculated for polycarbonate.

6. The composition of claim 1, wherein the composition is free of a poly(carbonate-siloxane) having a siloxane content that is less than 30 weight percent, each based on the total weight of the poly(carbonate-siloxane).

7. The composition of claim 1, wherein the poly(carbonate-siloxane), the poly(methyl methacrylate), or both are derived from post-consumer recycled or post-industrial recycled materials or can be produced from at least one monomer derived from bio-based or plastic waste feedstock.

8. The composition of claim 1, comprising 1 to 4 weight percent of the low density polyethylene.

9. The composition of claim 1, wherein the composition further comprises 0.1 to 10 weight percent, based on the total weight of the composition, of an additive composition.

10. The composition of claim 1, comprising
65 to 75 weight percent of the poly(methyl methacrylate);
12 to 25 weight percent of the poly(carbonate-siloxane);
1.5 to 3.5 weight percent of the low density polyethylene; and
optionally, 10 to 20 weight percent of an impact modifier.

11. The composition of claim 10, wherein
the poly(carbonate-siloxane) comprises bisphenol A carbonate repeating units and poly(dimethyl siloxane) repeating units;
the poly(carbonate-siloxane) has a weight average molecular weight of 25,000 to 45,000 g/mol;
the poly(carbonate-siloxane) has a siloxane content of 35 to 65 weight percent based on the total weight of the poly(carbonate-siloxane); and
wherein a molded sample of the composition exhibits:
a notched Charpy impact strength of 7 kJ/m² to 12 kJ/m² at 23° C., 4.2 J, as measured in accordance with ISO 179/1; and
a notched Izod impact strength of 6 kJ/m² to 11 kJ/m² at 23° C., 2.75 J, as measured in accordance with ISO 180; and
a hardness of 410 N/mm² to 550 N/mm², as measured in accordance with the Erichsen scratch hardness test at a force of 2 Newton (N); and
a pencil hardness as specified by D3363-92A of at least H at 0.75 kgf.

12. A method of making the composition of claim 1, the method comprising melt-mixing the components of the composition, and, optionally, extruding the composition.

13. An article comprising the composition of claim 1.

14. The article of claim 13, wherein the article is an automotive component or a consumer electronic component.

15. The article of claim 14, wherein the article is
an automotive body panel, an automotive instrument panel, an automotive console, automotive trim, an automotive visor; or
an electrical or lighting cover, an electrical or lighting housing, an electrical or lighting enclosure; or
a personal electronic device or a home appliance.
